(19) United States
(12) Patent Application Publication
(10) Pub. No.: US 2007/0205614 A1
(43) Pub. Date: Sep. 6, 2007

(54) Closable Pivot Handle Lock

(76) Inventor: Rainer Hoffmann, Langenfeld (DE)

Correspondence Address: ROBERT W. BECKER & ASSOCIATES, 707 HIGHWAY 333, SUITE B, TIJERAS, NM, 87059-7507, US

(21) Appl. No.: 11/681,496

(22) Filed: Mar. 2, 2007

(30) Foreign Application Priority Data
Mar. 2, 2006 (DE) 20 2006 003 307.6

(51) Int. Cl. E05C 3/16

(52) U.S. Cl. 292/226

(57) ABSTRACT

A pivot handle lock for doors or lids of cabinets or other receptacles, and comprising a housing insertable into a cutout of the door or lid and having a depression-like recess, in which is disposed a pivot handle that is provided with a grip depression and is pivotably out of the housing. A latch is pivotably mounted on a portion of the housing projecting from the inner side of the door or lid, the pivot handle being adapted to actuate the latch. A rotary lock having an actuating shaft supporting a rotatable tongue is disposed in the housing such that in a closed position of the rotary lock, the tongue blocks pivot movement of the latch.

The instant application should be granted the priority date of 02 Mar. 2006 the filing date of the corresponding German patent application DE 20 2006 003 307 6

### BACKGROUND OF THE INVENTION

The present invention relates to a pivot handle lock for doors or lids of cabinets or other receptacles.

To lock doors or lids, locks are known that are embodied as so-called pivot lever locks and are described, for example, in EP 0 261 266 B1. With such locks, a base plate is secured in position in a cutout provided in the door or lid; the base plate is elongated and has a recess for accommodating a handle that in the rest position is to be folded or pivoted therein. The handle can be pivoted out of the base plate in a plane that is directed perpendicular to the door or lid and is rotatably mounted at one end in the base plate via an actuating shaft that engages in a sleeve nut or also supports a tongue as a rocking device for the door or lid, so that in the pivoted-out position of the handle, the lock can be locked or unlocked by rotation thereof. The free end of the handle, which is opposite the connected actuation shaft, is provided with a cylinder lock by means of which the handle can be locked in the base plate when it is pivoted into the base plate. Thus, the pivot handle lock can be closed off.

The known lock has the drawback that operation thereof is cumbersome. First of all, after the cylinder lock is unlocked the handle must be pivoted out of the base plate and subsequently rotated for unlocking the lock. To the extent that the cylinder lock is mounted at the end of the handle, it obstructs handling of the handle and also makes it more difficult to pivot the handle into the base plate, because for this purpose the cylinder lock must be brought into alignment with the associated receiving opening of the base plate.

It is therefore an object of the present invention to provide a closable lock for doors or lids of cabinets or other receptacles that has a straightforward construction and can be actuated in a simple manner,

### BRIEF DESCRIPTION OF THE DRAWINGS

This object, and other objects and advantages of the present invention, will appear more clearly from the following specification in conjunction with the accompanying schematic drawings in which;

FIG. 1 is a front view of one exemplary embodiment of the inventive closable pivot handle lock;

FIG. 2 is a rear view of the lock of FIG. 1;

FIG. 3 is an exploded, detailed illustration of the individual components of the lock of FIGS. 1 and 2; and

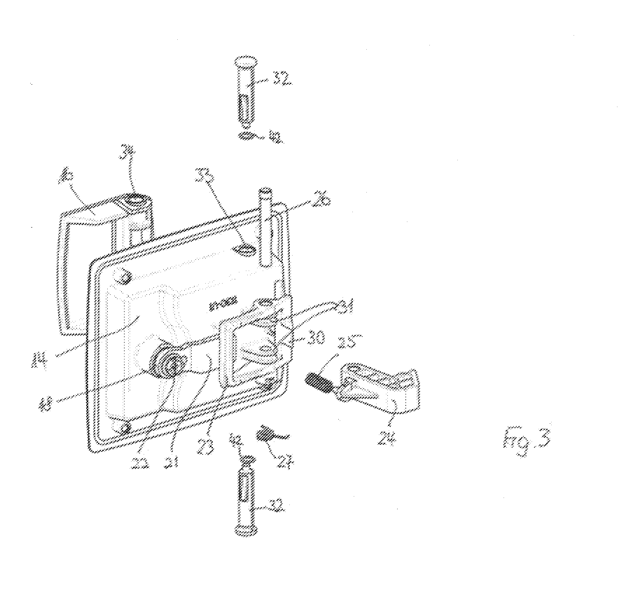

FIG. 4 is a different viewing angle of the subject matter of FIG. 3.

### SUMMARY OF THE INVENTION

The pivot handle lock of the present invention is provided with a housing that is insertable into a cutout of the door or lid and has a depression-like recess in which is disposed a pivot handle that is provided with a grip depression and is pivotable out of the housing, whereby the pivot handle is adapted to actuate a latch that is pivotably mounted on a portion of the housing that projects from the inner side of the door or lid, and whereby in addition to the pivot handle, a rotary lock having an actuating shaft that supports a rotatable tongue is disposed in the housing in such a way that in a closed position of the rotary lock the tongue is adapted to block the pivot movement of the latch.

The present invention has the advantage that for actuation of the lock it is sufficient to pivot the pivot handle out of the housing. There thus results only a single actuating direction with an actuating path that in addition is to be maintained for only a short period of time. Due to the separate arrangement of the cylinder lock in the housing, the cylinder lock does not disrupt the actuating process; nevertheless, due to the blocking of the latch, which is actuated by the pivot handle, in the closed position of the rotary lock that is provided, the pivot movement of the latch is blocked, so that the pivot handle lock can on the whole be dosed off.

Pursuant to one embodiment of the invention, a rocker member is provided that is actuated by the pivot handle when the latter is pivoted out of the housing whereby the rocker member is pivotably mounted on the housing, rests against and acts upon the latch via an extension, and wherein the tongue of the rotary lock blocks the path of rotation of the rocker member in the closed position of the rotary lock. Furthermore, the rocker member can be biased by a spring in its rest position, which sets the latching position of the latch. This first of ail ensures that the latch is respectively disposed in its latching position.

For the functional connection of the pivot handle and the latch, the pivot handle acts upon the rocker member by means of an actuating pin that is disposed so as to be longitudinally displaceable in the housing. The axis of rotation of the pivot handle, which can be pivoted out of the housing, can be disposed so as to be eccentric relative to the displacement axis of the actuating pin, and a lever arm that bridges the eccentricity can be provided on the pivot handle. Due to the thus provided coupling of rocker member and pivot handle, it is sufficient for merely the rocker member to be biased by a spring in its rest position that sets the latching position of the latch, because by means of the actuating pin simultaneously the spring force also acts upon the pivot handle and also holds the handle in its pivoted-in position in the housing that is provided by the latching position of the latch and is brought about thereby.

Pursuant to a preferred embodiment of the invention the latch can be mounted so as to be movable relative to the rocker member, and can be biased in its latching position by a spring. This results in two significant advantages. On the one hand, a snapping function of the latch during closing of the door or lid is provided thereby because even when the rocker member is blocked by the rotary lock, the door or lid can be pressed closed, whereby the latch is automatically pivoted into the open position against spring force relative to the rocker member which is fixed in position by the rotary lock, and hence permits the closing of the door or lock, while it is subsequently pressed back by the spring into its position that latches the door or lid. Furthermore, despite the closed-off pivot handle lock, it is possible to open the door or lid from the inside by manually pivoting the latch into its open position against the force of the spring that is acting upon it.

A simple manner of construction is provided if, pursuant to one embodiment of the invention, latch and rocker arm are mounted on a single pivot shaft that is disposed on that portion of the housing that projects from the inner side of the door or lid, and are rotatable about the pivot shaft. In this connection, for example, the spring that acts upon the rocker member can be embodied as a torsion spring that is placed upon the shaft and on the one hand engages against the rocker member and on the other hand is supported against the housing, while the spring that presses the latch can be embodied as a linearly acting compression spring that is supported against the housing.

Since with the embodiment of such a pivot lever lock in particular the tightness of a lock is important, so that the passage of the functional components of the pivot handle lock through the door panel is sealed, pursuant to one embodiment of the invention the actuating pin can be sealed relative to the housing by means of a seal that is placed in a groove formed on the pin. A further sealing of the pivot handle in the housing is realized if the hinge pins, which are provided for mounting the pivot handle in the housing and are mounted in openings of the housing, are sealed relative to the housing by seals placed therein. Similarly, pursuant to the invention the passage of the rotary lock in the housing is sealed by means of a seal. The housing itself is sealed at the surface where it rests against the door panel by means of a seal placed therein.

Further specific features of the present application will be described in detail subsequently.

### DESCRIPTION OF SPECIFIC EMBODIMENTS

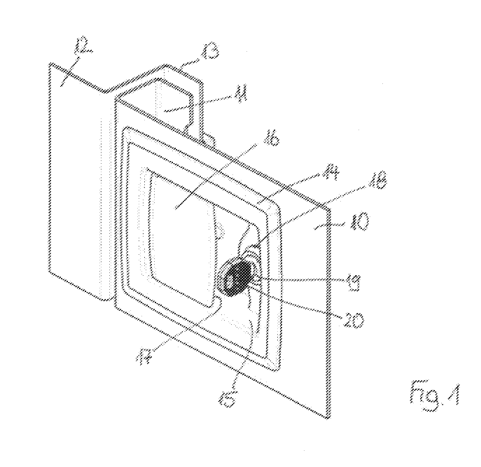

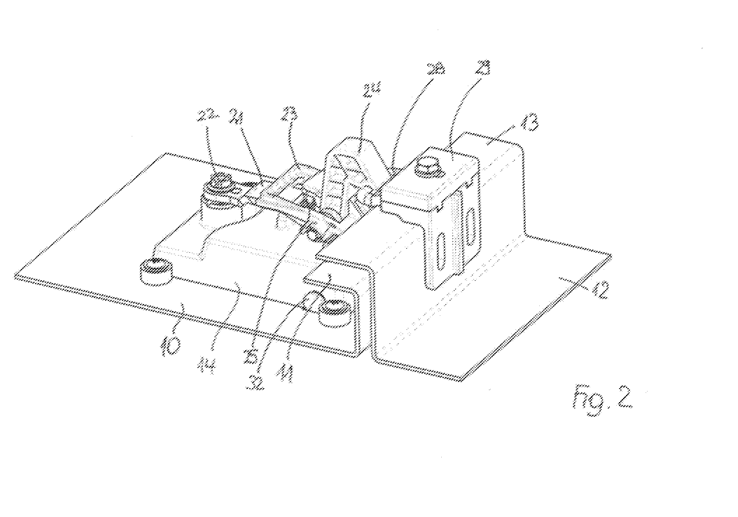

Referring now to the drawings in detail illustrated in FIG. 1 is a pivot handle lock that is installed in a door panel 10. The door panel has an angled-off portion 11 via which the door panel 10, in its closed position, comes to rest in a frame bracket 13 of a frame 12, whereby a closure means secures the door panel 10 relative to the frame 12, as can be seen in FIG. 2.

A housing 14 is disposed in a cutout formed in the door panel 10. The housing 14 is provided with a depression-like recess 15 in which is disposed a folding or pivot handle 16 that is provided with a grip depression 17. The pivot handle 16 is recessed in the recess 15, so that it does not project beyond it, yet can be folded or pivoted out of the housing 14 in a manner to be described subsequently. To seal the housing 14 relative to the door panel 10, a rim of the housing that surrounds its recess and rests against the door panel 10 is sealed against the door panel by means of a sealing means disposed in the nm.

On the housing side, a dome for accommodating a rotary lock 18 is furthermore formed in the recess 15; the rotary lock 18 is comprised of a cylinder lock 19 that is disposed in the dome and is actuatable by a key 20. As can be seen in FIG. 2, seated on the shaft of the rotary lock 18 is a tongue 21, which is secured to the shaft by means of a screw 22 in such a way that when the key 20 is turned, the tongue 21 respectively rotates together with the key. A sealing means is also provided for the passage of the rotary lock 18 through the housing 14.

As can be seen in FIG. 2, a rocker member 23 is pivotably mounted on the housing 14, which on the back side projects inwardly beyond the door panel 10. The rocker member 23 includes a latch or securing element 24s which is also pivotably mounted on the housing 14. The latch 24 is biased into a closed or latched position by a compression spring 24, which is supported on the housing 14t in its closed position, the latch 24 engages or catches behind a latch holder 28, which in turn is secured to the frame 12 by means of a securement bracket 29.

As can be better seen from Figs, 3 and 4, the rocker member 23 and the latch 24 are mounted together on a shaft 26 which is supported in bearing brackets 31 formed on the housing 14. In this connection, the latch 24 which is acted upon by the compression spring 25, is rotatably mounted on the region of the shaft 26 disposed between the bearing brackets 31 while the rocker member 23, which surrounds the latch 24 toward the outside, is supported on those portions of the shaft 26 that extend laterally beyond the bearing brackets 31. The rocker member 23 is introduced into its rest position, which enables the latching position of the late 24, by means of a torsion spring 27 that is placed on the shaft 26; one spring leg of the torsion spring 27 is supported against the rocker member 23, and the other spring leg is supported against a portion of the housing 14.

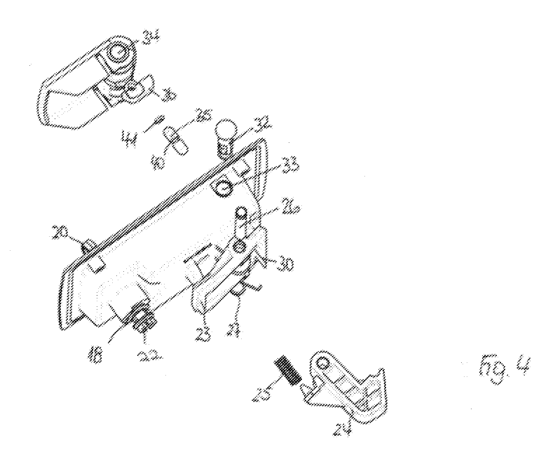

The pivot handle 16, which is disposed in the depression-like recess 16, is pivotably mounted on the housing 14 by means of two hinge pins 32, which are each inserted from the outside; the hinge pins respectively extend through an opening 33 in the housing 14 and a bearing opening 34 in the pivot handle 16. To transfer the pivot movement of the pivot handle 16 to a movement of the rocker member 23, an actuating pin 35 (FIG. 4) is provided that is longitudinally displaceable in the housing 14, whereby the axis of rotation, prescribed by the hinge pins 32, of the pivot handle 16, which can be pivoted out of the housing 14, is eccentric relative to the displacement axis of the actuating pin 35, whereby a lever arm 36 is formed on the pivot handle 16 to bridge this eccentricity. For sealing purposes, the actuating pin 35 is sealed relative to the housing 14 by means of a seal 41 that is disposed in a groove 40 formed on the actuating pin. To the extent that the pivot handle 16 is also mounted on the housing 14 via two hinge pins 32 that are mounted in openings 33 of the housing 14, seals 42 are placed on the hinge pins 32 and provide for a sealing of the pivot handle 16, or its mounting means, relative to the housing 14.

A pivoting of the pivot handle 16 out of the housing 14 leads to a longitudinal displacement of the actuating pin 35, which thereby pivots the spring-loaded rocker member 23. Since the rocker member 23 rests via an extension 30 against the latch 24, when the rocker member 23 pivots it presses the latch 24 against the effect of the compression spring 25 into a position in which the latch 24 is released from the latch holder 28, so that the door panel 10 can pivot away from the frame 12. After the pivot handle 16 is released, the rocker member 23, under the effect of the torsion spring 27 that acts upon it, again pivots back into its starting position, thereby displacing the actuating pin 35, which in turn provides for the pivoting-in of the pivot handle 16 into the recess 15.

The opening movement of the pivot handle 16 is blocked when the rotary lock 18 is in the closed position because the tongue 21 of the rotary lock 18 extends below the rocker arm 23 and thus holds it in position, so that the rocker member 23 cannot pivot, whereby due to the coupling of the rotational movement of the rocker arm 23 to the pivot handle 16 by means of the actuating pin 35, the pivoting movement of the pivot handle 16 is also blocked.

Since the latch 24, due to its independent mounting, is disposed on the shaft 26 so as to be movable relative to the rocker arm 23, and can thus carry out a pivoting movement even if the rocker member 23 is blocked by the tongue 21, there is hence on the one hand a snapping function when the door panel 10 is pushed into the frame 12, even if the rotary lock 18 is in the closed position, because the latch 24 bumps against the latch holder 28 via its angled-off latching surface and can thus pivot against the compression spring 25 until the latch 24 catches behind the latch holder 28.

At the same time, a safety function is also realized thereby, because the lock can also be opened from the inside of the door panel 10 when the rotary lock 18 is in the closed position for example by a person that is inside a receptacle that is closed off by the inventive pivot handle lock. For this purpose it is merely necessary to manually pivot the latch 24 against the effect of the compression spring 25 into its release position in which the latch 24 is released from the latch holder 28,

The features of the subject matter disclosed in the specification, claims and drawings can be important individually or in any combination with one another for realizing the various embodiments of the invention.

The specification incorporates by reference the disclosure of German priority document DE 20 2006 003 307.6 filed Mar. 2, 2006.

The present invention is, of course, in no way restricted to the specific disclosure of the specification and drawings, but also encompasses any modifications within the scope of the appended claims.

What I claim is:

1. A pivot handle lock for doors or lids of cabinets or other receptacles, comprising:
a housing (14) that is insertable into a cutout of a door (10) or lid, wherein said housing (14) is provided with a depression-like recess (15);
a pivot handle (16) disposed in said recess (15) and provided with a grip depression (17), wherein said pivot handle (16) is pivotable out of said housing (14);
a latch (24) pivotably mounted on a portion of said housing (14) that projects from an inner side of said door (10) or lid, wherein said pivot handle (16) is adapted to actuate said latch (24); and
a rotary lock (18) having an actuating shaft that supports a rotatable tongue (21), wherein said rotary lock (18) is disposed in said housing (14) in such a way that in a closed position of said rotary lock, said tongue (21) is adapted to block pivot movement of said latch (24),

2. A pivot handle lock according to claim 1, wherein a rocker member (23) is rotatably mounted on said housing (14), wherein said rocker member (23) is adapted to be actuated by said pivot handle (16) upon pivoting of said pivot handle out of said housing (14)3 wherein said rocker member (23) is provided with an extension (30) that rests against said latch (24) and acts thereupon, and wherein said tongue (21) of said rotary lock (18) is adapted to block a path of rotation of said rocker member (23) in said closed position of said rotary lock.

3. A pivot handle lock according to claim 2, wherein a spring (27) is provided for biasing said rocker member (23) in a rest position that sets a latching position of said latch (24).

4. A pivot handle lock according to claim 23 wherein an actuating pin (35) is longitudinally displaceably disposed in said housing (14), and wherein said pivot handle (16) is adapted to act upon said rocker member (23) via said actuating pin (35).

5. A pivot handle lock according to claim 43 wherein an axis of rotation (32) of said pivot handle (16) is eccentrically disposed in said housing (14) relative to a displacement axis of said actuating pin (35), and wherein a lever arm (36) is provided on said pivot handle (16) for bridging the eccentricity.

6. A pivot handle lock according to claim 2, wherein said latch (24) is mounted so as to be movable relative to said rocker member (23), and wherein a spring (25) is provided for biasing said latch (24) into a latching position.

7. A pivot handle lock according to claim 2, wherein a single pivot shaft (26) is disposed on said portion of said housing (14) that projects from the inner side of said door (10) or lid, and wherein said latch (24) and said rocker member (23) are mounted on said single pivot shaft (26) and are rotatable thereabout.

8. A pivot handle lock according to claim 4, wherein said actuating pin (35) is sealed relative to said housing (14) by means of a seal (41) that is placed in a groove (40) formed on said actuating pin (35).

9. A pivot handle lock according to claim 1, wherein two hinge pins (32) are mounted in openings (33) of said housing (14), wherein said hinge pins (32) are sealed relative to said housing (14) via seals (42) placed in said openings (33), and wherein said pivot handle (16) is mounted in said housing (14) via said hinge pins (32).

10. A pivot handle lock according to claim 9, wherein a passage of said rotary lock (18) in said housing (14) is sealed via a sealing means.

11. A pivot handle lock according to claim 1, wherein said housing (14) is sealed at a surface thereof that is adapted to rest against said door (10) or lid via a sealing means placed on said housing (14) or on said door (10) or lid.
